(19) United States
(12) Patent Application Publication
(10) Pub. No.: US 2013/0127925 A1
(43) Pub. Date: May 23, 2013

(54) READING APPARATUS AND CONTROL METHOD THEREOF

(71) Applicants: CHENG-HAO LEE, Hsinchu City (TW); CHING-LIANG YANG, Hsinchu city (TW); HUA-CHIEN HUNG, Hsinchu City (TW)

(72) Inventors: CHENG-HAO LEE, Hsinchu City (TW); CHING-LIANG YANG, Hsinchu city (TW); HUA-CHIEN HUNG, Hsinchu City (TW)

(73) Assignee: E Ink Holdings Inc., Hsinchu City (TW)

(21) Appl. No.: 13/585,940

(22) Filed: Aug. 15, 2012

(30) Foreign Application Priority Data
Nov. 17, 2011 (TW) 100140600

(51) Int. Cl. G09G 5/10

(52) U.S. Cl. 345/690; 345/107

(57) ABSTRACT

A control method for a reading apparatus, includes making a display screen of the reading apparatus display a first pattern with a first gray value according to a first display request; and making the display screen display a second pattern with a second gray value according to a second display request in a condition of the first pattern existing. The second gray value is different from the first gray value.

### FIELD OF THE INVENTION

The present invention relates to a reading apparatus, and more particularly to a control method for a reading apparatus.

### BACKGROUND OF THE INVENTION

In the recent years, the industry zealously develops the technology of the electronic display apparatus, such as the electrophoresis display apparatus, since the electrophoresis display apparatus has many advantages, such as light, thin and portable, etc. The electrophoresis display apparatus is able to reach a definite black gray and a definite white gray when it displays images, thus the electrophoresis display apparatus can make users feel the real sense same to read real books.

However, when the electrophoresis display device needs to perform an operation of hand input, a display image of the electrophoresis display apparatus still uses a color with a single gray value to display information of the hand input. At the moment, the information of the hand input and the content of the display image are displayed by a color with a same gray value, such that it will increase the difficulty of the user reading the reading apparatus. In addition, in the current technology of the hand input, when performing the operation of the hand input, the current electrophoresis display apparatus must display the information of the hand input on the display screen within a display period of about 260 milliseconds. Therefore, it will delay the display period of the hand input, the information of the hand input and the content of the original image cannot be distinctly distinguished, and it will generate the problem of covering words thereof.

### SUMMARY OF THE INVENTION

The present invention provides a reading apparatus and a control method thereof, which can reduce display time of information of hand input, does not generate a problem of covering words, and can distinctly distinguish the information of the hand input and content of an e-book.

In an exemplary embodiment of the present invention, a control method for a reading apparatus is provided, the control method includes making the display screen display a first pattern with a first gray value for responding a first display request, and making the display screen display a second pattern with a second gray value for responding a second display request in a condition of the first pattern existing, wherein the second gray value is different from the first gray value.

In an exemplary embodiment of the present invention, the first pattern is content of an e-book, and the second pattern is information of hand input.

From an another point of view, in an exemplary embodiment of the present invention, a reading apparatus is provided, the reading apparatus includes a display screen, a display-controlling module and a gray-controlling tool. The display screen has a plurality of pixel units which are arranged in an array, and the display screen is electrically coupled to the display-controlling module. In addition, the gray-controlling tool is also electrically coupled to the display-controlling module. The gray-controlling tool makes the display-controlling module generate a first driving voltage to drive the pixel units according to a first display request, so as to display a first pattern with a first gray value on the display screen. In addition, the gray-controlling tool further makes the display-controlling module generate a second driving voltage to drive at least parts of the pixel units for responding a second display request, so as to display a second pattern with a second gray value on the display screen in a condition of the first pattern existing. The second gray value is different from the first gray value.

The present invention may display the first pattern and the second pattern with the different gray values on the display screen for responding the first display request and the second display request respectively. Therefore, when applying the hand input, the present invention can reduce the display time of the information of the hand input, and does not generate the problem of covering words thereof, and can distinctly distinguish the information of the hand input and the content of the reading apparatus.

### BRIEF DESCRIPTION OF THE DRAWINGS

The present invention will become more readily apparent to those ordinarily skilled in the art after reviewing the following detailed description and accompanying drawings, in which:

FIG. 1 is a block view of a reading apparatus in accordance with an exemplary embodiment of the present invention.

FIG. 2 is an inner-structure schematic view of a display screen in accordance with an exemplary embodiment of the present invention.

FIG. 3A is a schematic view for displaying a first pattern in accordance with an exemplary embodiment of the present invention.

FIG. 3B is a schematic view for displaying a second pattern in accordance with an exemplary embodiment of the present invention.

FIG. 4 is a schematic view for displaying content of different pages of an e-book respectively in accordance with an exemplary embodiment of the present invention.

FIG. 5 is a schematic view of an operation of switching different pages in accordance with an exemplary embodiment of the present invention.

FIG. 6 is a schematic view for displaying a second pattern in accordance with an exemplary embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

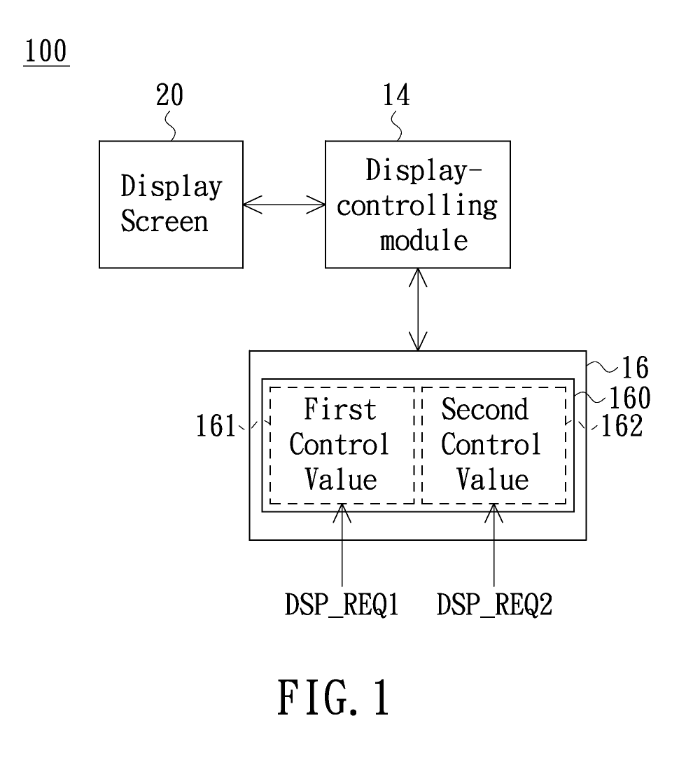

FIG. 1 is a block view of a reading apparatus in accordance with an exemplary embodiment of the present invention. Referring to FIG. 1, the reading apparatus 100 of the exemplary embodiment includes a display-controlling module 14, a gray-controlling tool 16 and a display screen 20. In the exemplary embodiment, the display-controlling module 14 is electrically coupled to the gray-controlling tool 16 and the display screen 20.

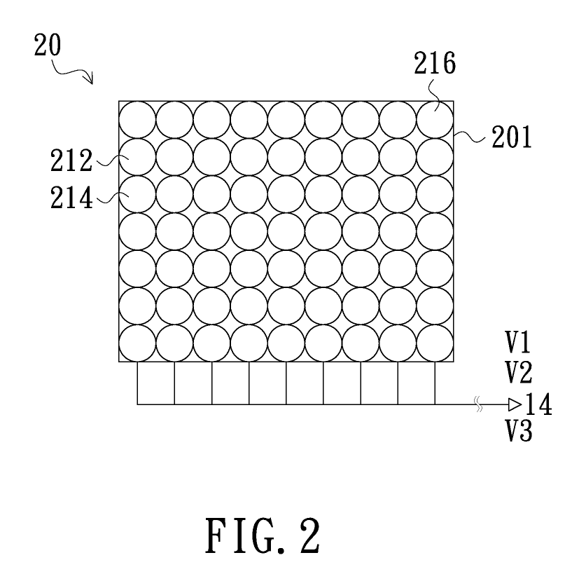

FIG. 2 is an inner-structure schematic view of a display screen 20 in accordance with an exemplary embodiment of the present invention. Referring to FIG. 2, the display screen 20 of the exemplary embodiment may be a touch display screen, such as a resistive touch display screen, a capacitive touch display screen, an infrared touch display screen, an electromagnetic touch display screen, a pressure-controlled touch display screen, an acoustic-wave touch display screen, which has a pixel-array module 201. In addition, the pixel-array module 201 includes a plurality of pixel units, such as 212, 214 and 216, and the pixel units are arranged in an array. In some embodiments, the pixel units may be electrophoresis units. Therefore, the display screen 20 may keep displayed images without providing power, and it consumes the power only when updating images, such that the reading apparatus of the exemplary embodiment can obtain the advantage of saving the power.

Referring to FIGS. 1 and 2 together, in the exemplary embodiment, the gray-controlling tool 16 includes a storing unit 160 configured for storing a first control value 161 and a second control value 162. When the gray-controlling tool 16 receives a first display request DSP_REQ1, the display-controlling module 14 generates a first driving voltage V1 according to the first control value 161. Thereafter, the display-controlling module 14 transmits the first driving voltage V1 to the pixel-array module 201, to drive each of the pixel units. At the moment, the display screen 20 displays a first pattern with a first gray value.

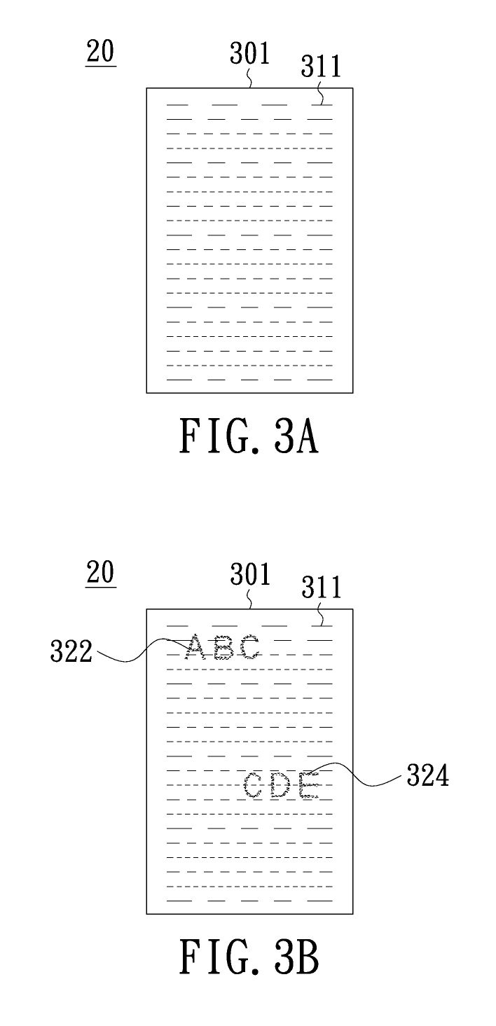

In some embodiments, the first display request DSP_REQ1 may require the reading apparatus 100 to display the content of an e-book on the display screen 20 as the first pattern, which is shown as FIG. 3A. That as shown in FIG. 3A, is the content 311 of a page 301 of an e-book.

Then, when the display screen 20 displays the first pattern, if the gray-controlling tool 16 receives a second display request DSP_REQ2, the display-controlling module 14 generates a second driving voltage V2 according to the second control value 162. Therefore, the display-controlling module 14 can use the second driving voltage V2 to drive parts of the pixel units of the pixel-array module 201, such that the display screen 20 displays a second pattern with a second gray value. The second gray value is different from the first gray value.

FIG. 3B is a schematic view for displaying the second pattern in accordance with an exemplary embodiment of the present invention. Referring to FIG. 3B, in some embodiments, the second display request DSP_REQ2 may be an operation of hand input. At the moment, the user may employ an object, such as a touch pen or a finger, to input information of the hand input, such as 322 and 324, on the display screen 20. When the object contacts with the display screen 20, the gray-controlling tool 16 will make the display-controlling module 14 to turn on the corresponding pixel units. Then, the display-controlling module 14 drives the turned-on pixel units according to the second driving voltage V2 generated by the second control value 162. Therefore, the information of the hand input (that is, the second pattern) is displayed by the second gray value. Thus, the exemplary embodiment of the present invention can make the user write the information on the page of the e-book by the hand input. Since the gray value of the information of the hand input is different from the gray value of the content of the e-book, the information of the hand input will not be covered by the content of the e-book. From another point of view, the content of the e-book also will not be influenced by the information of the hand input.

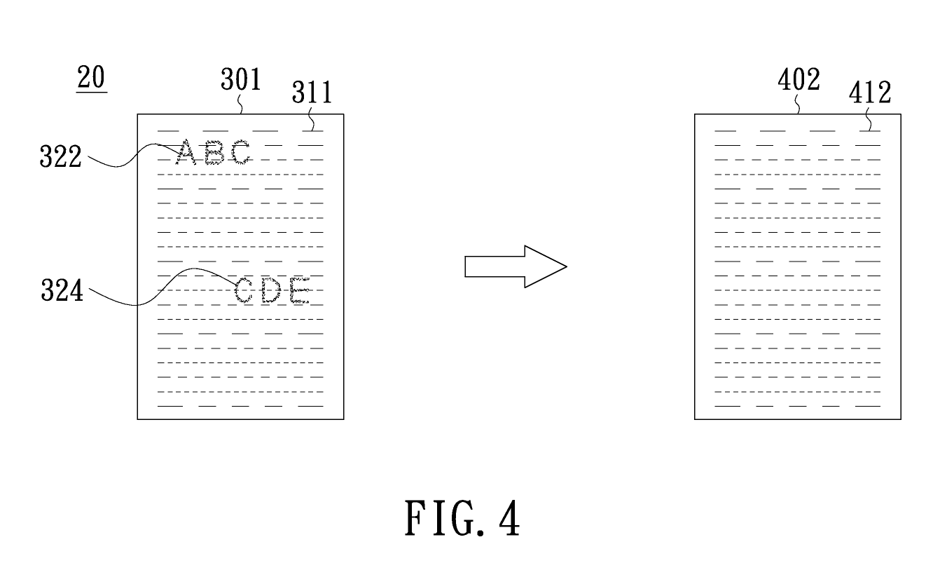

Referring to FIGS. 1 and 2 continuously, after the above, when the gray-controlling tool 16 receives the first display request DSP_REQ1 again, it may represent the user operates the reading apparatus 100 to display the content of a different page of the e-book, such as the content 412 of a page 402 as shown in FIG. 4. At the moment, the gray-controlling tool 16 makes the display-controlling module 14 to generate the first driving voltage V1 to drive the pixel units of the pixel-array module 201 again. Therefore, the display screen 20 display the first pattern with the first gray value, such as the content 412 of the page 402. Thus the information 322 and 324 of the hand input on the previous page 301 is eliminated.

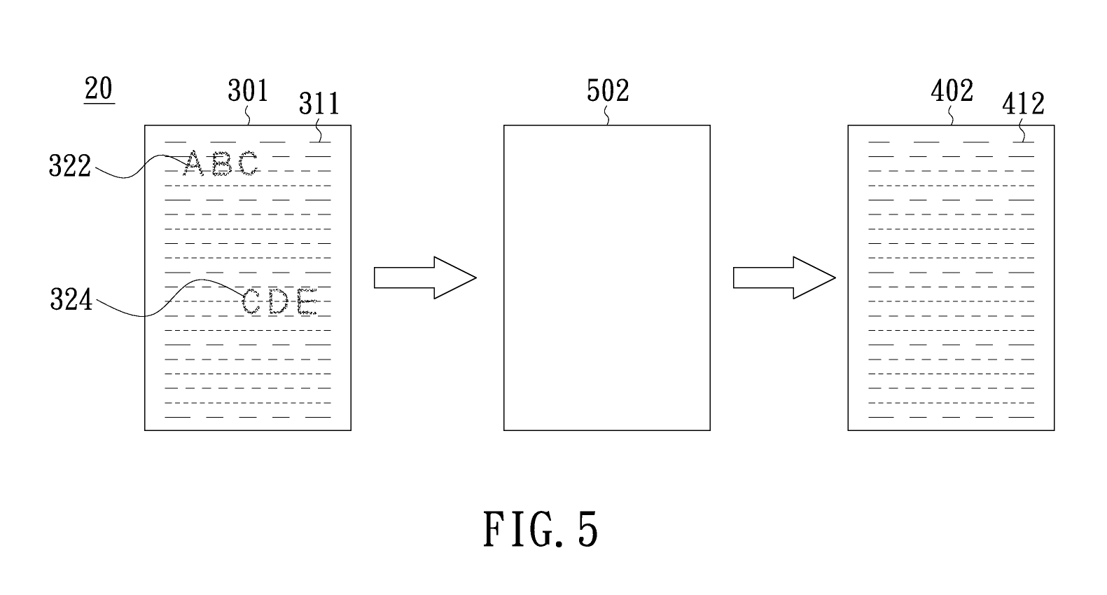

FIG. 5 is a schematic view of an operation for switching different pages in accordance with an exemplary embodiment of the present invention. Referring to FIG. 5, when switching different pages, such as controlling the display screen 20 to switch to display the page 402 from the page 301, a whole-white page 502 is inserted between displaying the page 301 and the page 402. Therefore, the exemplary embodiment of the present invention can effectively eliminate the ghost of the images, and reduce the response time of each of the pixel units of the pixel-array module 201.

Referring to FIG. 1 again, in some embodiments, the second pattern may be stored in the storing unit 160. Therefore, when the display-controlling module 14 makes the display screen 20 display the first pattern, the gray-controlling tool 16 can make the display-controlling module 14 display the corresponding second pattern on the display screen 20.

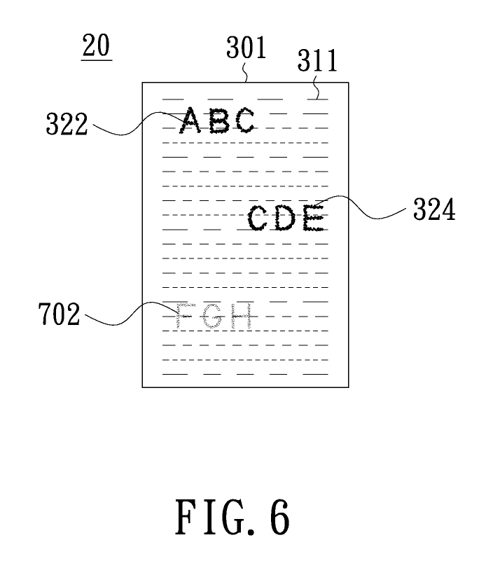

In addition, in some alternative embodiments, the storing unit 160 further stores a third control value. FIG. 6 is a schematic view of displaying the second pattern in accordance with another exemplary embodiment of the present invention. Referring to FIGS. 1, 2 and 6, in the exemplary embodiment, when the display-controlling module 14 makes the display screen 20 display the content 311 of the page 301 again, the gray-controlling tool 16 can make the display-controlling module 14 turn on the corresponding pixel units according to the previous second pattern, that is the information 322 and 324 of the hand input. Then, the display-controlling module 14 generates a third driving voltage V3 according to the third control value. Thus, the display-controlling module 14 can use the third driving voltage V3 to drive the turned-on pixel units. Therefore, the previous second pattern, such as the information 322 and 324 of the hand input, is displayed by the third gray value. The present-displayed second pattern, such as the information 702 of the hand input, is still displayed by the second gray value. Therefore, the user is prone to distinguish what is the second pattern.

And so forth, the storing unit 160 may store a plurality of control values. Therefore, the gray-controlling tool 16 may make the display-controlling module 14 generate different driving voltages, such as the second pattern edited by different sequence may be displayed on the display screen 20 by different gray values.

In summary, the exemplary embodiment of the present invention may make the display screen display the second pattern when displaying the first pattern on the display screen, and the gray values of the first pattern and the second pattern are different. Therefore, the present invention can reduce the display time of the information of the hand input, and does not occur the problem of covering words thereof, and can distinctly distinguish the information of the hand input and the content of the reading apparatus.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A control method for a reading apparatus, the reading apparatus having a display screen, the control method comprising:
making the display screen display a first pattern with a first gray value for responding a first display request; and
making the display screen display a second pattern with a second gray value for responding a second display request in a condition of the first pattern existing, wherein the second gray value is different from the first gray value.

2. The control method according to claim 1, wherein the first display request is an operation for making the reading apparatus display an e-book, and the first pattern is content of the e-book.

3. The control method according to claim 2, further comprising:
inserting a white image when switching a previous page to a next page, when the display screen is controlled to switch content of different pages of the e-book.

4. The control method according to claim 1, wherein the display screen comprises a plurality of pixel units, and the steps of displaying the first pattern comprises:
turning on the pixel units; and
generating a first driving voltage according to a first control value to drive the pixel units, so as to make the display screen display the first pattern with the first gray value.

5. The control method according to claim 1, wherein the display screen is a touch display screen, the second display request is an operation of a hand input, and the second pattern is information of the hand input.

6. The control method according to claim 5, wherein the display screen comprises a plurality of pixel units, and the step of displaying the second pattern comprises:
turning on the pixel units corresponding to the information of the hand input; and
generating a second driving voltage according to a second control value, to drive the turned-on pixel units, so as to make the display screen display the second pattern with the second gray level.

7. A reading apparatus, comprising:
a display screen, having a plurality of pixel units which are arranged in an array;
a display-controlling module, electrically coupled to the display screen; and
a gray-controlling tool, electrically coupled to the display-controlling module, to make the display-controlling module generate a first driving voltage to drive the pixel units for responding a first display request, so as to display a first pattern with a first gray value on the display screen, and make the display-controlling module generate a second driving voltage to drive at least parts of the pixel units for responding a second display request, so as to display a second pattern with a second gray value on the display screen in a condition of the first pattern existing, wherein the second gray value is different from the first gray value.

8. The reading apparatus according to claim 7, wherein the display screen is a touch display screen.

9. The reading apparatus according to claim 7, wherein the gray-controlling tool comprises a storing unit configured for storing a first control value and a second control value corresponding to the first driving voltage and the second driving voltage respectively.

10. The reading apparatus according to claim 7, wherein all of the pixel units are electrophoresis units.
